(19) United States
(12) Patent Application Publication
(10) Pub. No.: US 2007/0055187 A1
(43) Pub. Date: Mar. 8, 2007

(54) Adjustable massaging system

(76) Inventors: David R. Magnone, Raleigh, NC (US); Thomas A. McKearney, Raleigh, NC (US)

Correspondence Address: INTELLECTUAL PROPERTY / TECHNOLOGY LAW, PO BOX 14329, RESEARCH TRIANGLE PARK, NC, 27709, US

(21) Appl. No.: 11/363,908

(22) Filed: Feb. 28, 2006

Related U.S. Application Data
(60) Provisional application No. 60/657,029, filed on Feb. 28, 2005.

(51) Int. Cl. A61H 15/00

(52) U.S. Cl. 601/132

(57) ABSTRACT

A massaging system that applies massaging pressure to multiple points on the body and adjusts to differently sized users. In one implementation, the system includes a carrier having two separated compartments for holding essentially spherical masses, and a flexible member positioned between the separated compartments and connecting same, wherein at least the flexible member is fabricated of a stretchable material.

### BACKGROUND OF THE INVENTION

1. Field of Invention

The present invention relates to a massaging device, and more particularly, to a massaging system that applies massaging pressure to multiple points on a body and adjusts to different sized users.

2. Description of the Related Art

There are multiple massaging devices available that include moving spherical surfaces for massaging different areas on a subject. For example, Henderson, U.S. 2003/0144616 describes an elongated sac comprising two tennis balls that freely move within the sac. However, because the balls are freely movable within the sac, they can also easily move out of the desired massaging position when pressure is applied.

Devlin, US 2004/0243035 describes a tubular sleeve that includes a pair of tennis balls. Interestingly, the tubular sleeve is fabricated of a fabric having a pile that engages with the fuzzy napped surface of the tennis balls in an attempt to prevent the balls from moving within the sleeve. However, because the sleeve fits so snuggly about the balls, there is limited extendibility of the tubular sleeve, and as such, limited adjustability of the sleeve for use by different sized users.

Gardner, U.S. Pat. No. 5,577,996 describes a hand held rigid rod comprising two spherical masses mounted thereon. The spherical masses can be moved along the rod to adjust for different sized subjects. However, because of the rigidity of the system, it is difficult to use in a chair or automobile seat and not easily packed for trips.

Panahpour, U.S. Pat. No. 4,796,616 describes a massaging apparatus having a plurality of balls mounted vertically and horizontally in a framework and positioned in an opening so that a portion of each ball projects beyond the framework for contact with a user's body. However, this system is quite large and not amenable to easy packing or providing comfort in an automobile seat or office chair.

Accordingly, there is a need for a more compact and portable massaging device that overcomes the shortcomings of the prior art devices.

### SUMMARY OF THE INVENTION

The present invention relates to an adjustable massaging system comprising:
a carrier comprising two separated compartments for holding essentially spherical masses; and
a flexible member positioned between the separated compartments and connecting same,
wherein at least the flexible member is fabricated of a stretchable material.

The flexible member can be fabricated of the same material as the separated compartments and be integral therewith. In the alternative, the flexible member can be of a separate and distinct material from that of the separated compartments and attached therewith.

In another aspect, the present invention relates to an adjustable system comprising
a carrier comprising two separated compartments for holding essentially spherical masses, wherein the compartments have an open end with closures for introducing the spherical masses; and
a flexible member positioned between the separated compartments and connecting same, wherein the flexible member is fabricated of a stretchable material and is of sufficient length to provide for twisting or folding of the flexible member thereby shortening the distance between the spherical masses.

In yet another aspect, the present invention provides for spherical masses comprising a spherical flexible container filled with a heat absorbing material for thermal heating in a microwave before use. Further, the material may include a cold absorbing material for inclusion in the freezer before use.

Any of the above-discussed embodiments may include handles attached to one end of each of the separated compartments.

In still another aspect, the present invention provides for a massaging method to ease tissue or muscle discomfort in a subject, the method comprising:
a) placing a massaging device on areas in need of massaging wherein the messaging device comprises:
   a carrier comprising two separated compartments for holding essentially spherical masses; and
   a flexible member positioned between the separated compartments and connecting same, wherein the flexible member is fabricated of a stretchable material; and
b) positioning the massaging device between the area in need of massaging and a relatively rigid surface for moving the massaging device against the area in need of massaging.

Other features and advantages of the invention will be apparent from the following detailed description, drawings and claims.

### BRIEF DESCRIPTION OF THE FIGURES

FIG. 1 illustrates an embodiment of the present invention wherein the flexible member is integral to the separated compartments.

FIG. 2 illustrates another embodiment wherein the flexible member is fabricated from an elastomeric material that is different from the material of the separated compartments and attached therewith.

FIG. 3 illustrates the embodiment of FIG. 1 in a stretched mode.

FIG. 4 illustrates the folding of the flexible member of FIG. 3 thereby shortening the distance between the separated compartments.

FIG. 5 illustrates yet another embodiment featuring a broader flexible member that provide a pouch region for introducing a cushioning type material for placement against a user's spinal column.

FIG. 6 illustrates another embodiment of the present invention.

FIG. 7 illustrates a preferred embodiment including stylized stitching for retaining the spherical masses within the separated compartments and loop handles for easy portability.

### DETAILED DESCRIPTION OF THE INVENTION

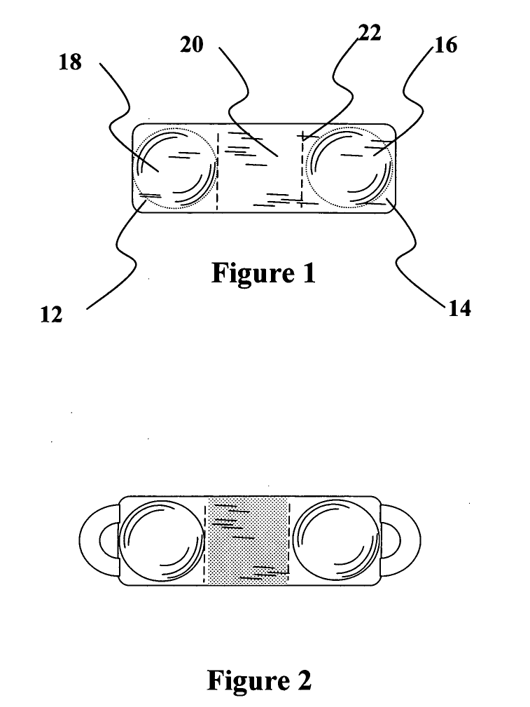

FIG. 1 describes a carrier 10 that include two (2) separated compartments 12 and 14 wherein each of the separated compartments includes a spherical mass 16 and 18. The carrier further includes a flexible member 20 positioned between compartments 12 and 14. Preferably, the distance between the compartments is approximately at least the diameter of one of the spherical masses and more preferably about two times the diameter of a spherical mass.

In the embodiment of FIG. 1 the flexible member and compartments are fabricated of the same flexible material. Any flexible material may be used in the present invention that provides stretchability for extending the area between the spherical masses. Acceptable materials include fabric or cloth made of nylon, Lycra, Tencel, spandex or any polymeric material with elasticity. Preferably, the material has a smoother surface than the spherical masses within the separated compartments thereby allowing the spherical masses to rotate, if necessary within the confines of the separated compartments. Stitching 22 is used to isolate and retain the spherical masses within the separated compartments.

In a preferred embodiment, the massage device includes a pair of hollow resilient spheres 16 and 18, such as tennis balls. Tennis balls are preferred because it has been found that the firm but resilient nature of such balls is well suited for massaging of tissue when used between the body of a user and a relatively rigid surface. Notably, although this embodiment shows two spherical masses, it is understood that more than two spherical masses may be included in this invention to provide an extended area of massaging pressure.

In the alternative, the spherical masses may include spherical containers that comprise a filing of loose non-absorbent small solid particles that are packed into the spherical containers. Preferably, the spherical containers are fabricated of a soft flexible material that allows movement of the loose particles therewithin while allowing filling of the container to a level that provides suitable support for maneuvering against the body of a user. The small solid particles may include polymeric pellets, such as polystyrene, or a material that is adaptable for quick heating in a microwave for deep heating during massaging of body parts or the material is adaptable for refrigeration for cooling of muscle tissue.

FIG. 2 shows an embodiment wherein the carrier includes two distinct types of material. The separated compartments may be fabricated from any flexible and smooth fabric for covering the spherical masses and the flexible member positioned between the separated compartments is fabricated from a highly elastic type material for sufficient stretching to increase the distance between the spherical masses. Further, handles can be easily included in this embodiment or any of the other embodiments discussed herein.

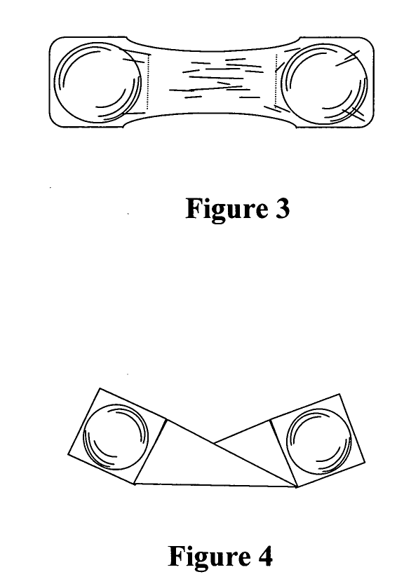

FIGS. 3 and 4 shows the adjustability of the present invention relating to use by different sized individuals. As shown in FIG. 3 the flexible member 20 can be of a sufficient length to comfortably fit a larger sized person with the spherical masses contacting the lumbar areas on opposite sides of the spinal column. The flexible member 20 can be shorten by merely folding or twisting same to provide for a shorter distance between the spherical masses, and thus, the massaging device is suited for a smaller sized individual while still contacting the points of interest. Preferably, the width of the flexible member is sufficiently wide to allow for the folding while maintaining a broad contact area of support against the spinal column.

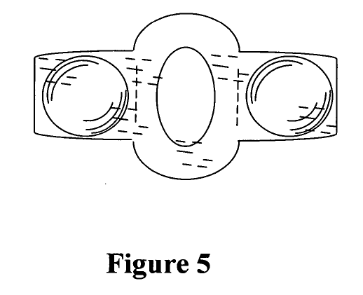

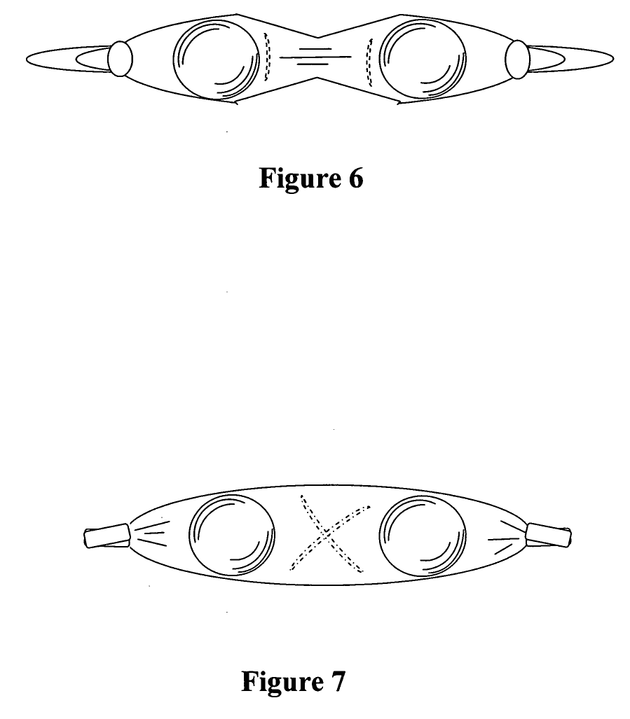

FIG. 5 provides an alternative embodiment wherein the flexible member, positioned between the two separated compartments, has an enlarged surface for placement of an additional padding insert. This embodiment is specifically designed for use with an individual having a sensitive spinal column area. The padding insert may include any soft pliable material that provides a cushioning effect between a rigid surface and the user, such as cotton batting, foam particles, polystyrene pellets or a microwavable and heatable material.

To use the massaging device of the present invention, the user places the spherical masses in the area that requires massaging. The user may then easily maneuver the spherical masses along the desired part on the user's body while applying the necessary pressure against, for example, the back of a seat. When the user leans against the massaging device, the spherical masses engage the body at spaced points as it is positioned between the user's body and a relatively rigid surface.

All the embodiments of the present invention are preferably fabricated from material that can be easily washed by the user for sanitization purposes. Further, the fabrication materials including the outer cover and the spherical masses can include an antimicrobial agent to reduce bacteria growth.

1. An adjustable massaging system comprising:
a carrier comprising two separated compartments for holding essentially spherical masses; and
a flexible member positioned between the separated compartments and connecting same,
wherein at least the flexible member is fabricated of a stretchable material.

2. The system according to claim 1, further comprising opposing handle connected to the separated compartments.

3. The system according to claim 1, wherein the flexible member is integral to the separated compartments and fabricated from a stretchable material with stitching to isolate and retain the spherical masses in the separated compartments.

4. The system according to claim 3, wherein the stretchable material is Lycra, tencel, or an elastomeric polymer.

5. The system according to claim 1, wherein the spherical masses are tennis balls.

6. The system according to claim 1, wherein the flexible member has a length of at least one diameter of the spherical masses.

7. The system according to claim 1, wherein the width of the flexible member is approximately the same size as the diameter of the spherical masses.

8. A massaging method to ease tissue or muscle discomfort in a subject, the method comprising:
a) placing a massaging device on areas in need of massaging wherein the messaging device comprises:
a carrier comprising two separated compartments for holding essentially spherical masses; and
a flexible member positioned between the separated compartments and connecting same, wherein the flexible member is fabricated of a stretchable material; and
b) positioning the massaging device between the area in need of massaging and a relatively rigid surface for moving the massaging device against the area in need of massaging.
